(19) United States
(12) Patent Application Publication
(10) Pub. No.: US 2026/0055746 A1
(43) Pub. Date: Feb. 26, 2026

(54) ROCKET MOTOR WITH DUAL EMBEDDED BURNABLE CUTTING EXPLOSIVE ENERGETIC MATERIAL

(71) Applicant: Raytheon Company, Arlington, VA (US)

(72) Inventors: David E. Hare, BEVERLY, MA (US); Mitchell L. Moffet, Tucson, AZ (US); Jacob A. Pinello-Benavides, Vail, AZ (US)

(21) Appl. No.: 19/278,459

(22) Filed: Jul. 23, 2025

Related U.S. Application Data
(60) Provisional application No. 63/685,113, filed on Aug. 20, 2024.

(51) Int. Cl. F02K 9/34; F02K 99/00

(52) U.S. Cl. CPC F02K 9/34; F02K 99/00

(57) ABSTRACT

A rocket motor has an energetic material between solid propellent and a casing that surrounds the solid propellent. The energetic material is configured to be burned along with the solid fuel during normal operation of the rocket motor to produce thrust. The energetic material can also be detonated to cause rupture of the casing and to break up the solid propellent without detonating the solid propellent.

The energetic material may be formed as part of one or more Embedded Charge Assemblies (ECAs) to distribute energy in the form of one or more pressure waves to rupture the casing or break up the solid propellent. The ECAs may be configured as a Linear Shaped Charge (LSC), Chevron, spherical charge or explosive. The detonation may be initiated as part of a flight termination process. The detonation may also be initiated as a part of process to prevent as a higher-order reaction, such as in reaction to heating from a fire or other cause. By being located inside the casing, the energetic material and ECAs do not adversely affect aerodynamics of the flight vehicle of which the rocket motor is a part, such as a missile.

### CLAIM OF PRIORITY

This patent application claims the benefit of priority to U.S. Provisional Application Ser. No. 63/685,113, filed Aug. 20, 2024, which is incorporated by reference herein in its entirety.

### FIELD

The present disclosure is in the field of devices and methods for propulsion using rocket motors.

### BACKGROUND

Insensitive munitions and range safety requirements necessitate devices capable of splitting the rocket motor of a missile, either to terminate flight or to prevent a high order reaction. Such devices have usually been placed on the outside of the missile body, increasing aerodynamic drag and potentially limiting the size of the rocket motor and the range of the system.

### SUMMARY

A rocket motor includes an energetic material and a solid propellent inside a casing, with the energetic material burnable along with the propellent to produce thrust, and also capable of being used to rupture the casing and/or to break-up the solid propellent to prevent operation of the rocket motor and/or cause flight termination of a flight vehicle (such as a missile) of which the rocket motor is a part.

According to an aspect of the disclosure, a rocket motor includes: a casing; a solid propellent; and an energetic material between the solid propellent and the casing; an initiator that is operatively coupled to the energetic material to detonate the energetic material; wherein the energetic material is configured to burn along with the propellent to produce thrust in the rocket motor; wherein a first portion of the energetic material is configured to be capable of detonation to rupture the casing, wherein a second portion of the energetic material is configured to be capable of detonation to break-up the solid propellent to terminate thrust.

According to an embodiment of any paragraph(s) of this summary, the solid propellent may be perforated solid propellent in which a central opening extends through the solid propellent along the long axis where the combustion of the solid propellent occurs, with combustion spreading radially outward from the central opening. Alternately, the solid propellent may be a Highly Loaded Grain (HLG), which does not have a central opening along the long axis, where the combustion of the solid propellent occurs at the aft face or end burning.

According to an embodiment of any paragraph(s) of this summary, the solid propellent and energetic material may or may not be the same material or may be the same material but of different specific compositions (e.g., different binders or different percentages of constituent components). The composition materials may, for example, include ammonium perchlorate (AP), Hexanitrohexaazaisowurtzitane (CL-20), Octogen (HMX), Cyclonite (RDX), or other base explosives. The base explosives are mixed with binders to make an energetic material that will burn or detonate. More broadly, energetic materials allowed per RCC-319 may be used, such as Comp A3, Comp A4, Comp A5, Comp CH6, DIPAM, HNS Type 1 or Type 2 Gr A, HNS-IV, LX-14, PBX 9407, PBXN-5, PBXN-6, PBXN-7, PBXN-9, PBXN-11, PBXN-12, or PBXN-301.

According to an embodiment of any paragraph(s) of this summary, wherein the first portion of the energetic material is part of at least one first embedded charge assembly (ECA) oriented along the long axis of the rocket motor and facing outward toward the casing, the at least one first ECA capable upon detonation of the first portion of the energetic material to rupture the casing and expose the solid propellent; and wherein the second portion of the energetic material is part of at least one second ECA oriented along the long axis and facing inward toward the solid propellent, the second ECA capable upon detonation of the second portion of the energetic material to break up the solid propellent into multiple pieces to terminate thrust without detonating the solid propellent.

According to an embodiment of any paragraph(s) of this summary, an ECA includes a charge liner configured to distribute sufficient energy in the form of one or more pressure waves to either rupture the casing or break up the solid propellent into multiple pieces. The charge liner is suitably formed of a material selected from metal, plastics, ceramics, or foam. All of the materials that constitute the ECA must burn or reduce to a sufficiently small size to ensure gas venting through the nozzle of the rocket motor during normal rocket motor operation to produce thrust.

According to an embodiment of any paragraph(s) of this summary, at least one first ECA is preferably a linear shaped charge (LSC) but may be a linear wedge charge or “Chevron”, a spherical charge (hemisphere, sectioned hemisphere or sphere) or an explosive or a combination thereof; and the at least one second ECA is one of a LSC, a linear wedge charge or “Chevron”, a spherical charge or an explosive or a combination thereof.

According to an embodiment of any paragraph(s) of this summary, the LSC includes a charge liner on a surface of the energetic material. The charge liner is preferably formed on a surface of a void in the energetic material. The void and charge liner are suitably “wedge or V-shaped”. The charge liner may face radially outward toward the casing or radially inward toward the solid propellent.

According to an embodiment of any paragraph(s) of this summary, the Chevron includes a charge liner on a surface of the energetic material. The charge liner suitably has an inverted wedge or inverted V-shape. The charge liner may face radially outward toward the casing or radially inward toward the solid propellent.

According to an embodiment of any paragraph(s) of this summary, the spheric charge includes a charge liner on a surface of the energetic material. The liner may have a hemispheric, sectioned hemispheric or spherical shape, and may face radially outward or inward.

According to an embodiment of any paragraph(s) of this summary, the explosives may be a different energetic material that upon detonation is capable of rupturing the casing, breaking up the solid propellent or both.

According to an embodiment of any paragraph(s) of this summary, the rocket motor further includes an insulative material between the solid propellent and the energetic material that acts as a barrier or shock attenuator to prevent ignition and detonation of the solid propellent from the energetic material. The insulative material is preferably positioned around each of the ECAs. The insulative material is preferably a burnable material.

According to an embodiment of any paragraph(s) of this summary, an ECA may be configured as a single continuous uniform structure that extends along the long axis. For example, a single LSC or Chevron may extend along the longaxis. Alternately, a plurality of ECAs may be positioned to extend along the longaxis. The ECAs may all be of the same type or different types (e.g., alternating LSC and spherical). The ECAs may be separated by detonation (“det”) cord.

According to an embodiment of any paragraph(s) of this summary, wherein a single ECA or plurality of ECAs may be configured in a linear configuration that extends along the long axis. A pair of linear ECAs may be positioned 180 degrees apart. More generally, N linear ECAs may be positioned 360/N degrees apart. Alternately, the single ECA or plurality of ECAs in one or more lines may be wrapped circumferentially around and extending along the long axis as in a spiral configuration separated by 360/N degrees. N radial ECAs may be positioned along the axis and may be combined with M linear or spiral ECAs.

According to an embodiment of any paragraph(s) of this summary, the initiator is configured to trigger detonation of the energetic material upon occurrence of one or more circumstances including a temperature-related circumstance, a flight-related circumstance and active triggering by a remote operator.

According to another aspect of the disclosure, a rocket motor includes: a casing, a solid propellent; an energetic material; an initiator that is operatively coupled to the energetic material to detonate the energetic material; wherein the energetic material is configured to burn along with the solid propellent to produce thrust in the rocket motor; wherein the energetic material is configured to be capable upon detonation to rupture the casing or to break up the solid propellent into pieces.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1 is side view of a missile that includes a rocket motor, according to an embodiment of the disclosure.

FIG. 2 is a side view showing the missile of FIG. 1 in a container.

FIG. 3 is a side sectional view of part of the rocket motor of the missile of FIG. 1.

FIG. 4 is an end sectional view of part of the rocket motor of FIG. 3.

FIG. 5 is a side sectional view of the rocket motor of FIG. 3, as a first time in the process of detonation of the energetic material.

FIG. 6 is a side sectional view of the rocket motor of FIG. 3, as a second time in the process of detonation of the energetic material.

FIG. 7 is a side sectional view of the rocket motor of FIG. 3, as a third time in the process of detonation of the energetic material.

FIG. 8 is a side sectional view of the rocket motor of FIG. 3, as a fourth time in the process of detonation of the energetic material.

FIG. 9 is an end sectional view of the rocket motor of FIG. 3, at the fourth time illustrated in FIG. 8.

FIG. 10 is a side sectional view of the rocket motor of FIG. 3, as a fifth time in the process of detonation of the energetic material.

FIG. 11 is a high-level flow chart of a method according to an embodiment of the disclosure.

FIG. 12 is a high-level flow chart of a method according to another embodiment of the disclosure.

FIG. 13 is an end sectional view of a portion of a rocket motor, according to an alternate embodiment of the disclosure.

FIG. 14 is a side sectional view of a rocket motor with a dual embedded burnable cutting explosive energetic material for a HLG.

FIGS. 15A-15C are side and end sectional views of part of the rocket motor of the missile of FIG. 14 and a side sectional view of the part of the rocket upon detonation of the explosive energetic material.

FIG. 16 is a high-level flow chart of a method of rupturing the rocket motor and breaking up the solid propellent according to an embodiment of the disclosure.

FIGS. 17A-17E are end sectional views of an integrated ECA including an outward facing LSC to rupture the casing and one of an inward facing LSC, Chevron charge, hemispheric charge, spherical charge, or explosive charge to break up the solid propellent.

FIGS. 18A-18F are perspective views of different configurations for a plurality of ECAs that extend along the long axis of the rocket motor to break up the solid propellent.

### DETAILED DESCRIPTION

A rocket motor has an energetic material between solid propellent and a casing that surrounds the solid propellent. The energetic material is configured to be burned along with the solid propellent during normal operation of the rocket motor to produce thrust. The energetic material can also be detonated to cause rupture of the casing and/or to break up of the solid propellent without detonating the solid propellent. The detonation may be initiated as part of a flight termination process. The detonation may also be initiated as a part of process to prevent as a higher-order reaction, such as in reaction to heating from a fire or other cause. The energetic material may be arranged as part of at least one embedded charge assembly (ECA), able to split the casing or break-up the solid propellent when detonated. Each ECA may, for example, include a portion of the energetic material as part of a LSC, Chevron, spherical charge or explosive charge. By being located inside the casing, the energetic material does not adversely affect aerodynamics of the flight vehicle of which the rocket motor is a part, such as a missile. And by being burnable along with the solid fuel to produce thrust from the rocket vehicle, the energetic material contributes to efficiency in normal operation of the rocket motor.

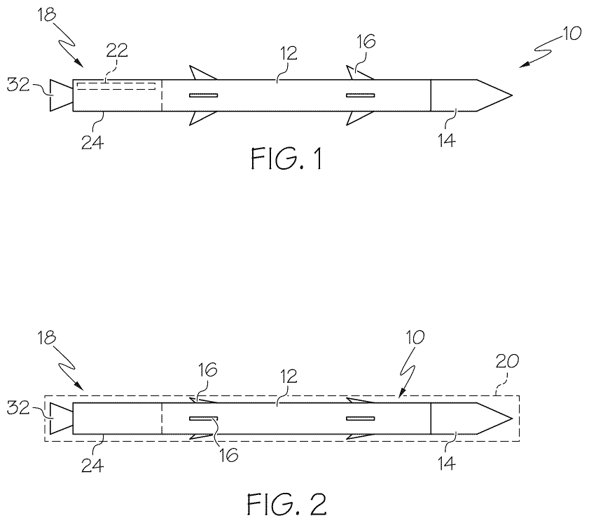

FIGS. 1 and 2 shows a missile 10 that includes a fuselage 12, a payload 14 (such as a warhead), control surfaces 16 (for example fins and/or canards), and a rocket motor 18 to provide thrust for flight. As shown in FIG. 2, the missile 10 may be contained within a cannister 20 during transport and storage.

As described further below, the rocket motor 18 is configured with an energetic material 22 that is able to split a casing 24 of the rocket motor 18, in order to render the rocket motor 18 inoperative to produce thrust. This may be done during flight to terminate flight, by initiating detonation of energetic material with a detonator or initiator. Alternatively, this may be as a safety measure, to rupture the casing 24 when the missile 10 reaches a predetermined temperature or range of temperatures, to render the rocket motor 18 inoperative when exposed to fire or other heating during transportation or storage (or otherwise when not in flight).

Alternatively, the energetic material 22 may be burned as part of or along with the fuel (propellent) of the rocket motor 18, to produce thrust. Some of the energetic material 22 may be burned (along with propellent) to produce thrust, before a remainder of the energetic material 22 is detonated to rupture or split the casing 24.

Although the operation is described below in the context of the missile 10, it will be appreciated that principles described below may be usable other contexts. For example the principles may be used in rocket motors in other sorts of flight vehicles and/or munitions. For example the rocket motor as described in the various embodiments herein may be part of a spacecraft or a commercial rocket.

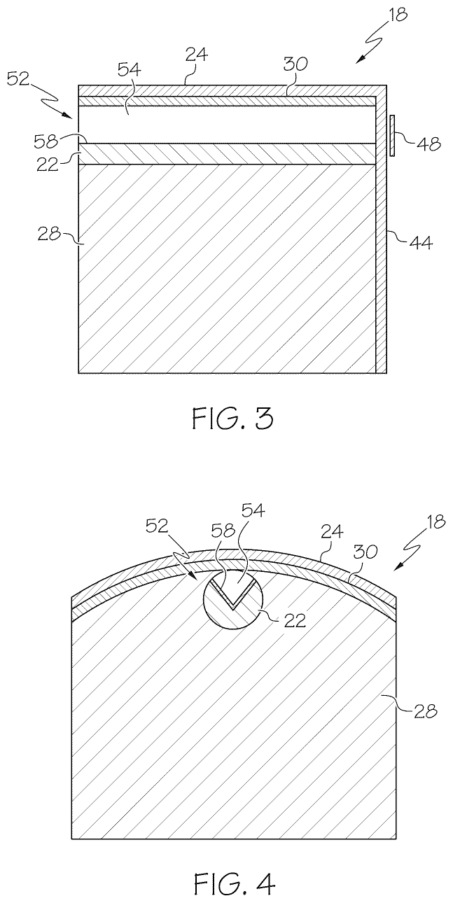

With reference now in addition to FIG. 3, details of the rocket motor 18 are now discussed. The rocket motor 18 includes the casing 24 surrounding a solid rocket fuel (propellent) 28. The casing 24 may have a casing liner 30 on the inside of the casing 24.

The rocket fuel (propellent) 28 may have a suitable shape with a central opening (not shown) where the combustion of the rocket fuel 28 occurs, with combustion spreading radially outward from the central opening. This burning of the solid fuel 28 produces pressurizes gasses, which exit the casing 24 through a nozzle 32 (FIG. 1) at an aft end of the casing 24, producing thrust that propels the missile 10.

The casing 24 may be made of steel or a composite material, and the casing liner 30 may be made of phenolic or a polymeric material. The solid rocket fuel 28 may be of any of a variety of solid fuel materials, for example materials such as ammonium perchlorate.

The energetic material 22 is located inside the casing 24, between the solid fuel 28 and the casing 24. The energetic material 22 may be located inside of the casing liner 30. The energetic material 22 may be situated along a surface of the casing liner 30. The solid propellent and energetic material may or may not be the same material or may be the same material but of different specific compositions (e.g., different binders or different percentages of constituent components). The composition materials may, for example, include ammonium perchlorate (AP), Hexanitrohexaazaisowurtzitane (CL-20), Octogen (HMX), Cyclonite (RDX), or other base explosives. The base explosives are mixed with binders to make an energetic material that will burn or detonate. More broadly, energetic materials allowed per RCC-319 may be used, such as Comp A3, Comp A4, Comp A5, Comp CH6, DIPAM, HNS Type 1 or Type 2 Gr A, HNS-IV, LX-14, PBX 9407, PBXN-5, PBXN-6, PBXN-7, PBXN-9, PBXN-11, PBXN-12, or PBXN-301.

The energetic material 22 may extend along an axial direction of the rocket motor 18. The energetic material 22 may extend aftward from a forward bulkhead 44 of the casing 24. The energetic material 22 may extend aftward over part or all of the length of the rocket motor 18. An initiator 48 for the energetic material 22 may be located on the bulkhead. The initiator 48 may be an exploding foil initiator that includes a thin conductive foil that is heated and vaporized by application of an electric current. The vaporization of the metal foil accelerates a flyer, such as made of steel or aluminum, and causes the flyer to impact the bulkhead 44. The shock from the impact of the flyer on the bulkhead 44 traverses the bulkhead 44 to detonate the energetic material 22.

Other types of detonators or initiators for the energetic material 22 are possible. For example, a detonator may also be placed directly against the bulkhead 44 to rely on strictly shock transfer through the bulkhead 44 to initiate detonation of the energetic material 22.

Referring now in addition to FIG. 4, the energetic material 22 may be configured as a linear shaped charge 52, to direct (focus) the force of the detonation of the energetic material 22 radially outward to split (rupture) the casing 24. To that end, the energetic material 22 has a wedge-shape opening (void) 54, in which the energetic material 22 does not extend. A charge liner 58 is on a surface of the energetic material 22 that adjoins the wedge-shaped opening 54. The charge liner 58 may be a metal material such as aluminum, or a plastic material, such as high density polyethylene (HDPE) or nylon, or a ceramic material such as aluminum oxide.

Detonation of the energetic material 22 proceeds aft from the bulkhead 44. The shape of the energetic material 22 concentrates explosive energy in the void 54. This drives the charge liner 58 into the void 54, making the charge liner 58 into a jet that drives into and through the casing 24. This causes a bulge in and eventually rupture of the casing 24.

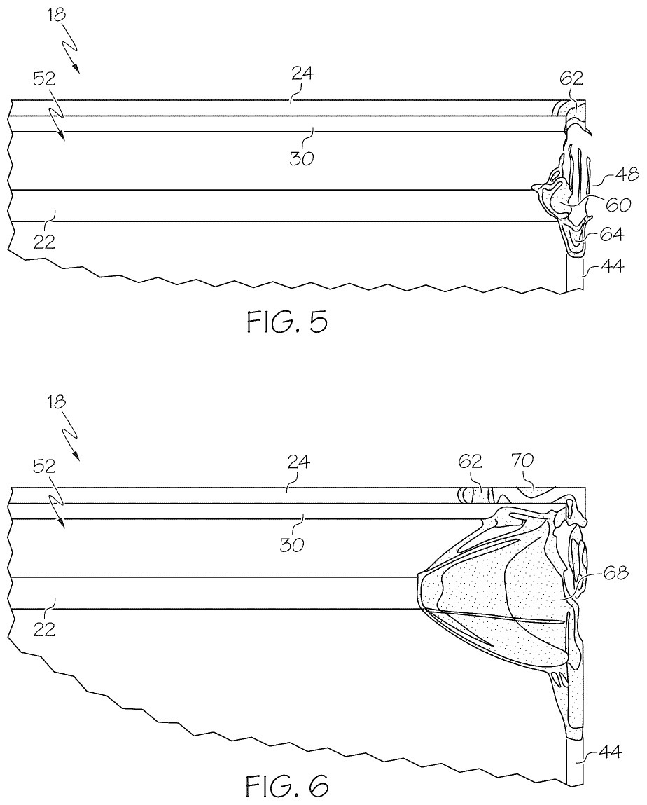

FIGS. 5-10 illustrate the process of rupturing the casing 24 using the linear shaped charge 52. FIG. 5 illustrates the condition just after initiation of the detonation of the energetic material 22 by the initiator 48. The region where the detonation is felt is indicated by reference number 60. Shock from the collision of the flyer with the bulkhead 44 also propagates upward through the bulkhead 44 to the casing 24, as shown at 62, as well as downward through the bulkhead, at 64.

FIG. 6 shows a later time, with the detonation of the energetic material 22 propagating in an axial direction away from the bulkhead 44, in a detonation region 68. Near the bulkhead 44 the material from the charge liner 58 has moved upward from the force of the detonation of the underlying energetic material 22, nearly reaching the casing 24. The upward initiation shock 62 has progressed in an axial direction past a casing portion 70 where the material from the detonation of the linear shaped charge 52 is about to reach the casing 24.

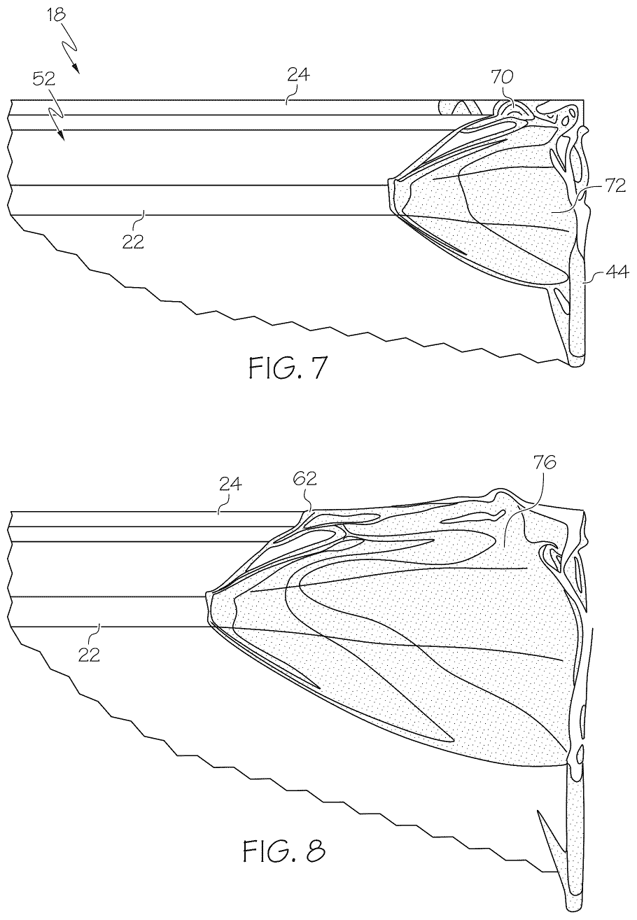

FIG. 7 shows the increased stress in the casing portion 70 of the casing 24 where the initial rupture will occur, at the edge of a detonation region 72. The detonation of the energetic material 22 of the linear shaped charge 52 has also caused deformation of the bulkhead 44.

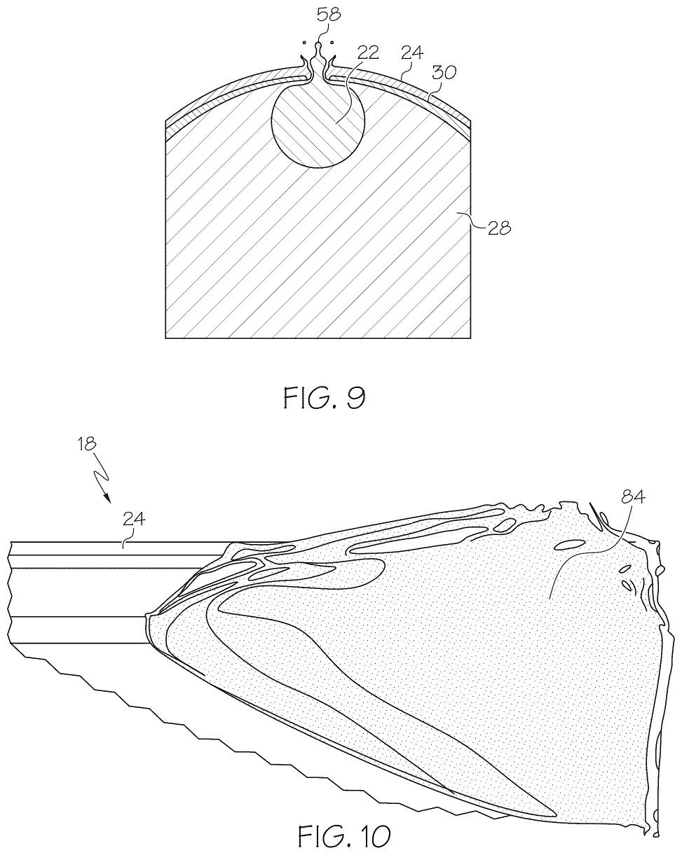

FIG. 8 shows the situation with rupture of the casing 24 having begun, with a detonation region 76 extending through the casing 24. The detonation of the energetic material 22 continues in an axial direction (leftward in the figure), with the stress in the casing 24 having caught up with the upward initiation shock 62 which has continued propagation along the casing 24 in the same axial direction. An end sectional view of this condition is shown in FIG. 9.

FIG. 10 shows the situation at a further time in the process, with the rupture of the casing 24 increasing in an axial direction, the same direction in which the energetic material 22 continues the process of detonation, in a detonation region 84. The rupture of the casing 24 prevents the rocket motor 18 (FIG. 1) from operating to produce thrust.

The rupture of the casing 24 may also cause rupture of the storage cannister 20 (FIG. 2), if the missile 10 (FIG. 1) is stored in the cannister 20 at the time of detonation of the energetic material 22. This allows release of pressure from materials escaping from the casing 24.

When the rocket motor 18 operates normally to produce thrust by burning of the propellent 14, the energetic material 22 is not explosively detonated by the combustion. Instead, the energetic material is also burned in the combustion process, and adds to the thrust produced by the rocket motor 18. The use of the energetic material 22 to provide thrust advantageously provides for more efficient use of the weight of the rocket motor 18. Unlike prior configurations where an energetic material is used solely for rupture of a casing, the energetic material 22 here provides an additional function of being configured to produce thrust during normal operation of the rocket motor 18.

The rocket motor 18 advantageously has the energetic material 22 within the casing 24. This avoids detrimental effects on aerodynamics of the missile 10 (FIG. 1) that may result from having the termination devices outside of a casing.

The initiator 48 may be activated automatically upon the occurrence of one or more circumstances. For example the initiator 48 may be configured to initiate detonation of the energetic material 22 (and the linear shaped charge 52) when a certain temperature or range of temperatures is reached. The temperature for triggering the initiator 48 may be the temperature of the initiator 48 itself. Alternatively or in addition there may be one or more temperature sensors, placed in appropriate places in the missile 10 and/or the container 20, that may be used for determining when to activate the initiator 48.

The circumstances for triggering the initiator 48 may include non-temperature-related circumstances. This may be done to terminate the flight upon completion of the test shot or erratic flight, so that the shot does not leave a test range. For example the initiator 48 may be triggered by a determination of some flight condition, such as erratic maneuvering, exhaustion of fuel, or exceeding a predetermined time after launch. The components such as the energetic material 22 and the initiator may be components of a flight termination system (FTS).

Alternatively or in addition, the initiator 48 may be actively triggered, for example by receiving a signal from a remote operator. A remote operator may send such a signal (for example) to terminate flight of the missile for one or more reasons, with the signal sent by radio to the missile 10, and forwarded within the missile 10 to the initiator 48, to detonate the energetic material 22 and terminate flight.

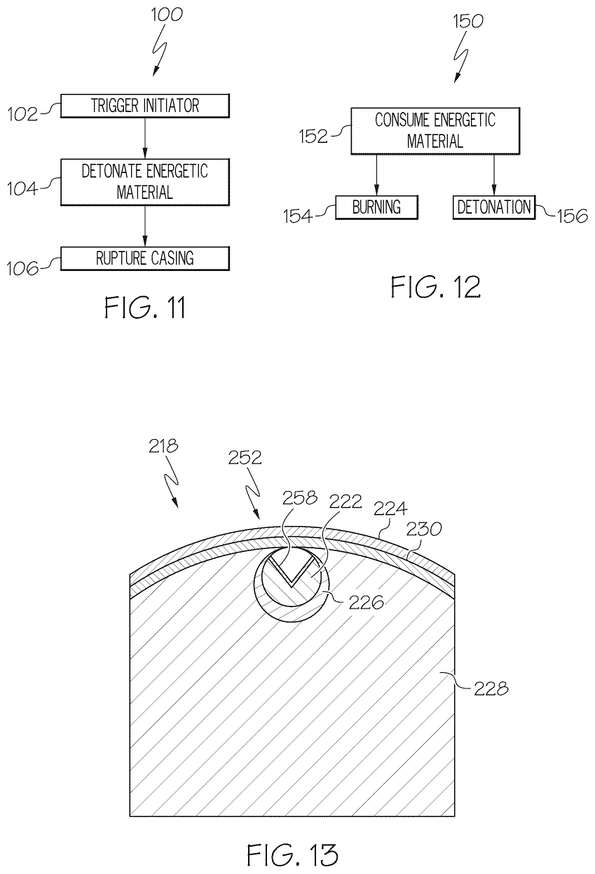

FIG. 11 shows a high-level flow chart of a method 100 of rupturing the casing 24 (FIG. 1) using the linear shaped charge 52 (FIG. 3). In step 102 the initiator 48 (FIG. 3) is triggered. As described above, the triggering of the initiator 48 may be automatic, upon the occurrence of one or more predetermined circumstances, or may be active, such as being controlled by an external operator.

In step 104 the burnable energetic material 22 (FIG. 3) is detonated, which activates the linear shaped charge 52 (FIG. 3), which is internal to the casing 24 (FIG. 3). Finally in step 106 the linear shaped charge 52 ruptures the casing 24 from within. As discussed above, this rupturing may occur axially along the casing 24, rupturing the casing 24 outward. This may serve as a flight termination, or may disable the rocket motor 18 when the missile 10 is on the ground or in storage, and is exposed to heat, such as from a fire.

FIG. 12 shows a high-level flow chart of a method 150 of operating the missile 10. In step 152 the energetic material 22 (FIG. 1) is consumed. This may be accomplished in one (or both) of two different modes, in respective steps 154 and 156. In the first mode 154 the energetic material 22 is burned along with the propellent 28 (FIG. 3), in normal (thrust-producing) operation of the rocket motor 18 (FIG. 1). In the second mode 156 the energetic material 22 is detonated to rupture (split) the casing 24 (FIG. 1) of the rocket motor 18.

FIG. 13 shows a rocket motor 218 that has an alternative configuration, with an energetic material 222 separated from a solid rocket fuel (propellent) 228 by an insulative material 226. The energetic material 222 and a charge liner 258 together constitute a linear shaped charge 252 which is used to rupture a casing 224, in a manner similar to that of the rocket motor 18 (FIG. 1), as described above.

The insulative material 226 may function to prevent inadvertent detonation of the solid fuel 228 by detonated energetic material 222. The insulative material 226 may be a burnable material, that burns during normal operation of the rocket motor 218, along with the burnable energetic material 222 and solid fuel 228. An example of a suitable material for the insulative material 226 is high density polyethylene (HDPE) or nylon.

Conventional rocket motors include a central opening that extends the length of the solid propellent. Newer Highly Loaded Grains (HLGs) do not have a central opening that extends the length of the grain. Depending in part on the diameter of the rocket motor, the composition of the solid propellent and whether the solid propellent does or does not have a central opening, the configuration of the energetic material such as with an outward facing LSC to only rupture the casing may be insufficient to satisfy the requirements for Insensitive Munitions (IMs). In these rocket motors it may be desired or required to further configure the rocket motor, and more particularly the energetic material to both rupture the casing and break-up the solid propellent into multiple pieces (without detonation of the solid propellent) upon initiation and detonation of the energetic material.

A given mission for a rocket motor will dictate the volume, hence diameter of the rocket motor and solid propellent, the total impulse thrust, composition of the solid propellent, and whether a conventional center perforated rocket motor or HLG (end-burning) rocket motor is used. The diameter of the solid propellent, whether a central opening exists and the mechanical properties of the solid propellent (e.g., is the solid propellent brittle or soft) in turn inform the selection, configuration and orientation of the energetic material and the ECAs and to break-up the solid propellent.

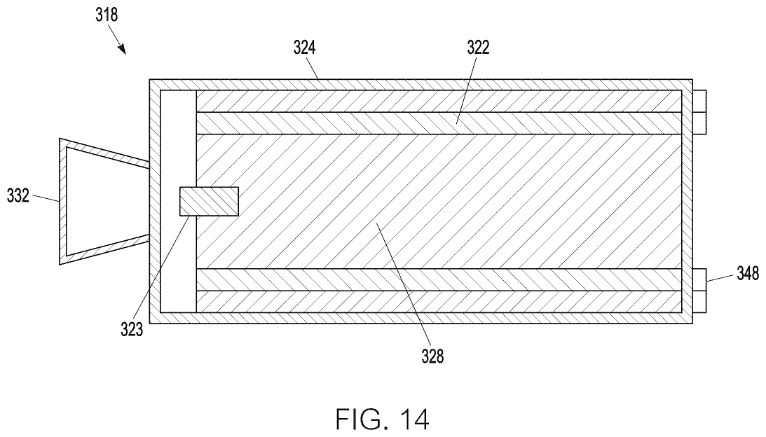

FIG. 14 shows a rocket motor 318 configured with a solid propellent 328 within a casing 324. In this instance, solid propellent 328 is a Highly Loaded Grain (HLG). The rocket motor 318 is configured with an energetic material 322 that is able to split casing 324 and break up solid propellent 328 of the rocket motor 318, in order to render the rocket motor 318 inoperative to produce thrust without detonating solid propellent 328. This may be done during flight to terminate flight, by initiating detonation of energetic material with an initiator 348 such as a single multipoint detonation system. Alternatively, this may be as a safety measure, to rupture the casing 324 when a missile reaches a predetermined temperature or range of temperatures, to render the rocket motor 318 inoperative when exposed to fire or other heating during transportation or storage (or otherwise when not in flight).

Alternatively, the energetic material 322 may be burned as part of or along with the fuel (propellent) of the rocket motor 318, upon ignition by an igniter 323 to produce thrust. This burning of the solid propellent 328 produces pressurizes gasses, which exit the casing 324 through a nozzle 332 at an aft end of the casing 324, producing thrust that propels the missile.

Some of the energetic material 322 may be burned (along with propellent) to produce thrust, before a remainder of the energetic material 322 is detonated to rupture or split the casing 324 and break up the solid propellent 328 into multiple pieces without detonating.

Although the operation is described below in the context of a missile, it will be appreciated that principles described below may be usable other contexts. For example the principles may be used in rocket motors in other sorts of flight vehicles and/or munitions. For example the rocket motor as described in the various embodiments herein may be part of a spacecraft or a commercial rocket.

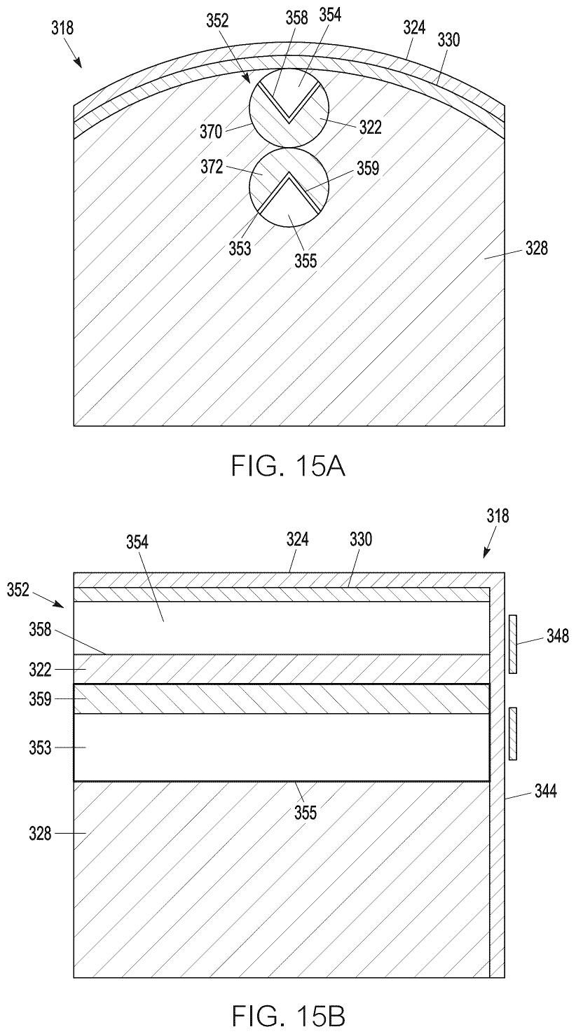

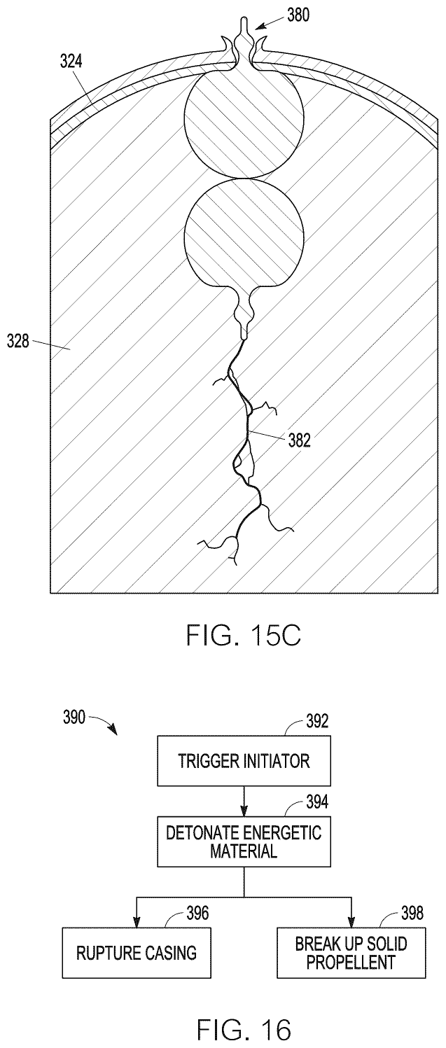

With reference now in addition to FIG. 15A, details of the rocket motor 318 are now discussed. The rocket motor 318 includes the casing 324 surrounding a solid propellent 328. The casing 324 may have a casing liner 330 on the inside of the casing 324.

The solid propellent 328 is a HLG. The combustion of the solid propellent 328 occurs across the aft face of the HLG. This burning of the solid propellent 328 produces pressurizes gasses, which exit the casing 324 through nozzle 332 (FIG. 14) at an aft end of the casing 324, producing thrust that propels the missile.

The casing 324 may be made of steel or a composite material, and the casing liner 330 may be made of phenolic or a polymeric material. The solid propellent 328 may be of any of a variety of solid fuel materials, for example materials such as ammonium perchlorate.

The energetic material 322 is located inside the casing 324, between the solid propellent 328 and the casing 324. The energetic material 322 may be located inside of the casing liner 330. The energetic material 322 may be situated along a surface of the casing liner 330. The solid propellent 328 and energetic material 322 may or may not be the same material or may be the same material but of different specific compositions (e.g., different binders or different percentages of constituent components). The composition materials may, for example, include ammonium perchlorate (AP), Hexanitrohexaazaisowurtzitane (CL-20), Octogen (HMX), Cyclonite (RDX), or other base explosives. The base explosives are mixed with binders to make an energetic material that will burn or detonate. More broadly, energetic materials allowed per RCC-319 may be used, such as Comp A3, Comp A4, Comp A5, Comp CH6, DIPAM, HNS Type 1 or Type 2 Gr A, HNS-IV, LX-14, PBX 9407, PBXN-5, PBXN-6, PBXN-7, PBXN-9, PBXN-11, PBXN-12, or PBXN-301.

The energetic material 322 may extend along an axial direction of the rocket motor 318. The energetic material 322 may extend aftward from a forward bulkhead 344 of the casing 324. The energetic material 322 may extend aftward over part or all of the length of the rocket motor 318. An initiator 348 for the energetic material 322 may be located on the bulkhead. The initiator 348 may be an exploding foil initiator that includes a thin conductive foil that is heated and vaporized by application of an electric current. The vaporization of the metal foil accelerates a flyer, such as made of steel or aluminum, and causes the flyer to impact the bulkhead 344. The shock from the impact of the flyer on the bulkhead 344 traverses the bulkhead 344 to detonate the energetic material 322.

Other types of detonators or initiators for the energetic material 322 are possible. For example, a detonator may also be placed directly against the bulkhead 344 to rely on strictly shock transfer through the bulkhead 344 to initiate detonation of the energetic material 322.

Referring now in addition to FIG. 15B, a portion 370 of energetic material 322 may be configured as part of an Embedded Charge Assembly (ECA) 352 oriented along the long axis of the rocket motor and facing outward toward casing 324 and a portion 372 of energetic material 322 may be configured as part of an ECA 353 oriented along the long axis of the rocket motor and facing inward toward solid propellent 328. In this example, both the outward and inward facing ECAs are configured as linear shape charges (LSCs) although as will be described below the ECAs may be LSCs, Chevrons, spherical charges or explosives although the outward facing ECA 352 is typically a LSC.

ECA 352 distributes the force (energy) of the detonation of the energetic material 322 radially outward to split (rupture) the casing 324. To that end, the portion 370 of energetic material 22 has a wedge-shape opening (void) 354, in which the energetic material 22 does not extend. A charge liner 358 is on a surface of the portion 370 energetic material 22 that adjoins the wedge-shaped opening 354. The charge liner 358 may be a metal material such as aluminum, or a plastic material, such as high-density polyethylene (HDPE), ceramic or foam.

ECA 353 distributes the force (energy) of the detonation of the energetic material 322 radially inward to break up the solid propellent 328 into multiple pieces. To that end, the portion 372 of energetic material 322 has a wedge-shape opening (void) 355, in which the energetic material 322 does not extend. A charge liner 359 is on a surface of the portion 372 energetic material 22 that adjoins the wedge-shaped opening 355. The charge liner 359 may be a metal material such as aluminum, or a plastic material, such as high-density polyethylene (HDPE) or ceramic or foam.

Detonation of the energetic material 322 proceeds aft from the bulkhead 344. As shown in FIG. 15C, the shape of the portion 370 of energetic material 322 concentrates explosive energy in the void 354. This drives the charge liner 358 into the void 354, making the charge liner 358 into a jet that drives into and through the casing 324. This causes a bulge in and eventually rupture 380 of the casing 324. The shape of the portion 372 of energetic material 322 concentrates explosive energy in the void 355. This drives the charge liner 359 into the void 355, making the charge liner 359 into a jet that drives into and through the solid propellent 328 breaking the solid propellent into pieces along fracture lines 382. Because detonation of the energetic material 322 proceeds aft until it runs into the burn front of the solid propellent, the solid propellent is broken into pieces at the burn front effectively terminating thrust immediate (when in flight).

FIG. 16 shows a high-level flow chart of a method 390 of rupturing the casing 324 (FIG. 14) using the linear shaped charge 352 (FIG. 15B) and breaking up the solid propellent 328 (FIG. 15A) using the linear shaped charge 353 (FIG. 15B). In step 392 the initiator 348 (FIG. 14) is triggered. As described above, the triggering of the initiator 348 may be automatic, upon the occurrence of one or more predetermined circumstances, or may be active, such as being controlled by an external operator.

In step 394 the portion 370 of burnable energetic material 322 (FIG. 15A) is detonated, which activates the linear shaped charge 352 (FIG. 15B), which is internal to the casing 324 (FIG. 15A). Finally in step 396 the linear shaped charge 352 ruptures the casing 324 from within. As discussed above, this rupturing may occur axially along the casing 324, rupturing the casing 324 outward. Simultaneously in step 398 the linear shaped charge 353 breaks up the solid propellent 328 from within. This may serve as a flight termination, or may disable the rocket motor 318 when the missile is on the ground or in storage, and is exposed to heat, such as from a fire.

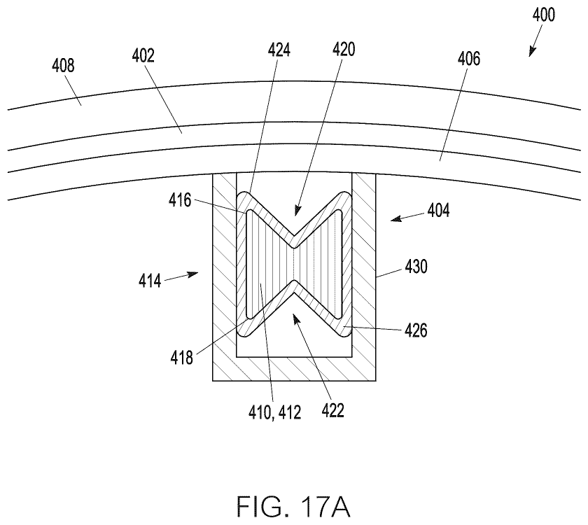

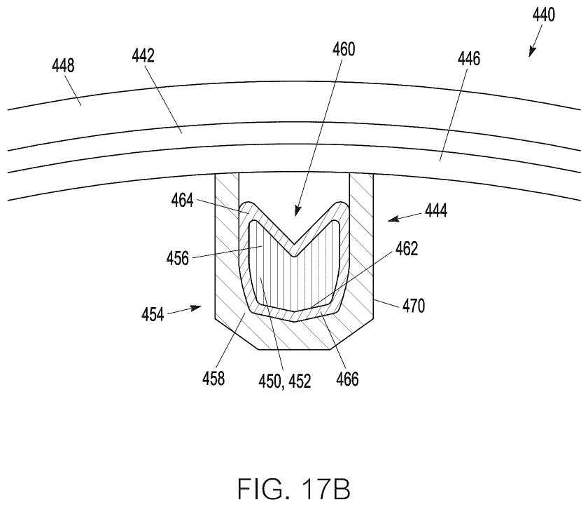

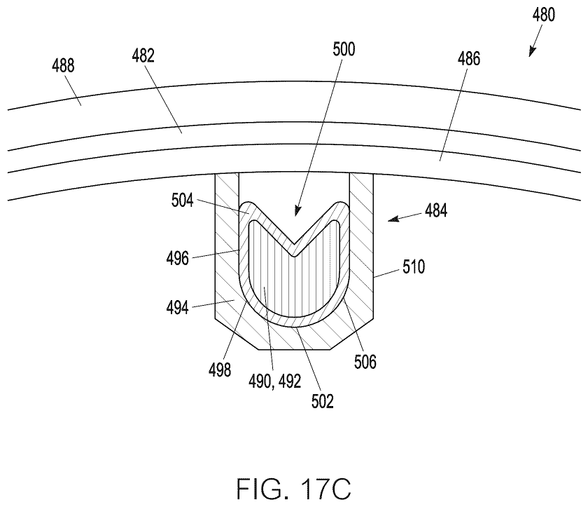

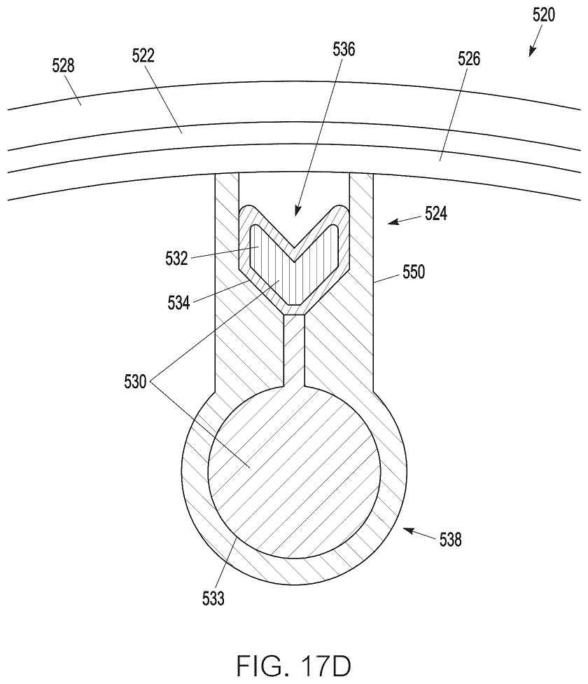

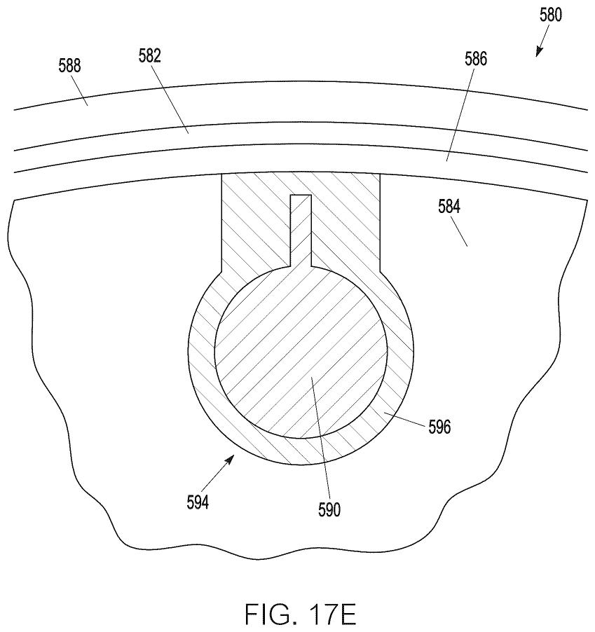

As mentioned above, the ECA may, for example, be a LSC, wedge-shaped charge or “Chevron”, a spherical charge (hemispheric, sectioned hemispheric or spherical), or an explosive. Typically, the outward facing ECA to rupture the casing is an LSC because the resulting jet is efficient at cutting the higher density rocket motor case. The inward facing ECA to break up the solid propellent may be any one of the LSC, Chevron, spherical charge or a combination thereof to most effectively and efficiently break up the solid propellent to terminate thrust. Furthermore, the outward facing and inward facing ECAs may be separate structures as depicted in FIG. 15B or they may be integrated into a single structure in which the first and second portions of the energetic material is a common portion of energetic material. The various configurations of the inward facing ECA as paired with an outward facing LSC are illustrated in FIGS. 17A-17E.

Referring now to FIG. 17A, an embodiment of a rocket motor 400 includes a casing 402 surrounding a solid propellent 404 such as a HLG. The casing 402 may have casing liners 406 and 408 on the inside and the outside of the casing 402, respectively. Energetic material 410 is located inside the casing 402, between the solid propellent 404 and the casing 402 and may extend aftward from a forward bulkhead of the casing 402 along a long axis of the rocket motor. A common portion 412 of energetic material 410 is configured as part of an integrated ECA 414 oriented along the long axis including an outward facing LSC 416 and an inward facing LSC 418. To that end, the common portion 412 of energetic material 410 has wedge-shape openings (voids) 420 and 422, in which the energetic material 410 does not extend. Charge liners 424 and 426 are on opposing surfaces of the common portion 412 energetic material 410 that adjoins the wedge-shaped openings 420 and 422. Upon detonation of energetic material 410 and common portion 412, LSC 416 generates an outward facing radial jet that ruptures casing 402 and LSC 418 generates an inward facing radial jet that breaks up solid propellent 404. The integrated ECA 414 is surrounded with an insulative material or shock attenuator 430 to distribute the one or more pressure waves to break up the solid propellent 404 without detonating it. The insulative may, for example, be a foam, silicone, plastic, lead, other metals, ceramics or build-ups of multiple materials to attenuate the pressure waves.

Referring now to FIG. 17B, an embodiment of a rocket motor 440 includes a casing 442 surrounding a solid propellent 444 such as a HLG. The casing 422 may have casing liners 446 and 448 on the inside and the outside of the casing 442, respectively. Energetic material 450 is located inside the casing 442, between the solid propellent 444 and the casing 442 and may extend aftward from a forward bulkhead of the casing 442 along a long axis of the rocket motor. A common portion 452 of energetic material 450 is configured as part of an integrated ECA 454 oriented along the long axis including an outward facing LSC 456 and an inward facing Chevron 458. To that end, the common portion 452 of energetic material 450 has a wedge-shape opening (voids) 460, in which the energetic material 450 does not extend, and a wedge-shaped protrusion 462, in which the energetic material 450 does extend. Charge liners 464 and 466 are on opposing surfaces of the common portion 452 energetic material 450 that adjoins the wedge-shaped opening 460 and wedge-shaped protrusion 462. Upon detonation of energetic material 450 and common portion 452, LSC 456 generates an outward facing radial jet that ruptures casing 442 and Chevron 458 projects material from the charge liner and one or more pressure waves inward to break up solid propellent 444. The integrated ECA 454 is surrounded with an insulative material or shock attenuator 470 to distribute the one or more pressure waves to break up the solid propellent 444 without detonating it.

Referring now to FIG. 17C, an embodiment of a rocket motor 480 includes a casing 482 surrounding a solid propellent 484 such as a HLG. The casing 482 may have casing liners 486 and 488 on the inside and the outside of the casing 482, respectively. Energetic material 490 is located inside the casing 482, between the solid propellent 484 and the casing 482 and may extend aftward from a forward bulkhead of the casing 482 along a long axis of the rocket motor. A common portion 492 of energetic material 490 is configured as part of an integrated ECA 494 oriented along the long axis including an outward facing LSC 496 and an inward facing hemispheric charge 498. To that end, the common portion 492 of energetic material 490 has a wedge-shape opening (voids) 500, in which the energetic material 490 does not extend, and a hemispheric protrusion 502, in which the energetic material 490 does extend. Charge liners 504 and 506 are on opposing surfaces of the common portion 492 energetic material 490 that adjoins the wedge-shaped opening 500 and hemispheric protrusion 502. Upon detonation of energetic material 490 and common portion 492, LSC 496 generates an outward facing radial jet that ruptures casing 482 and hemispheric charge 498 projects material from the charge liner and one or more pressure waves inward to break up solid propellent 484. The integrated ECA 494 is surrounded with an insulative material or shock attenuator 510 to distribute the one or more pressure waves to break up the solid propellent 484 without detonating it.

Referring now to FIG. 17D, an embodiment of a rocket motor 520 includes a casing 522 surrounding a solid propellent 524 such as a HLG. The casing 522 may have casing liners 526 and 528 on the inside and the outside of the casing 522, respectively. Energetic material 530 is located inside the casing 522, between the solid propellent 524 and the casing 522 and may extend aftward from a forward bulkhead of the casing 522 along a long axis of the rocket motor. A first portion 532 of energetic material 530 is configured as part of an outward facing LSC 536 and an inward facing Chevron 534. A second portion 533 of energetic material 530 is configured as part of an inward facing spherical charge 538. The second portion 533 may or may not be encased in a metal, plastic, or ceramic charge liner. Upon detonation of energetic material 530, LSC 536 generates an outward facing radial jet that ruptures casing 522 and Chevron 534 and spherical charge 538 projects material from the charge liner and one or more pressure waves inward to break up solid propellent 524. The LSC 536, Chevron 534 and spherical charge 538 are surrounded with an insulative material or shock attenuator 550 to distribute the one or more pressure waves to break up the solid propellent 524 without detonating it.

Referring now to FIG. 17E, an embodiment of a rocket motor 580 includes a casing 582 surrounding a solid propellent 584 such as a HLG. The casing 582 may have casing liners 586 and 588 on the inside and the outside of the casing 582, respectively. Energetic material 590 is located inside the casing 582, between the solid propellent 584 and the casing 582 and may extend aftward from a forward bulkhead of the casing 582 along a long axis of the rocket motor. Energetic material 590 is configured, in this case as a sphere to form an explosive charge 594, such that upon detonation of energetic material 590 produces pressure waves sufficient to rupture casing 582 and to break up solid propellent 584. The explosive charge 594 is surrounded with an insulative material or shock attenuator 596 to distribute the one or more pressure waves to break up the solid propellent 584 without detonating it.

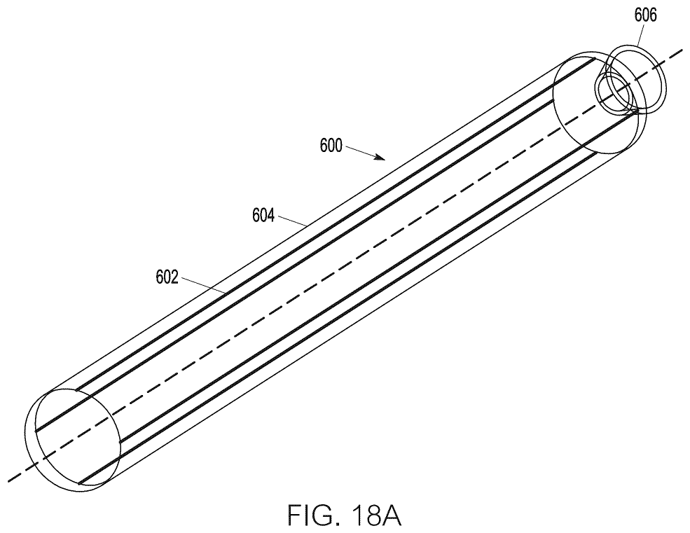

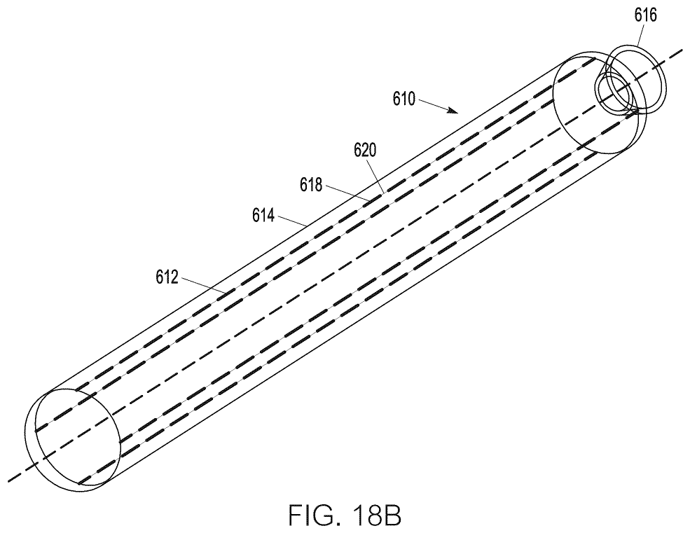

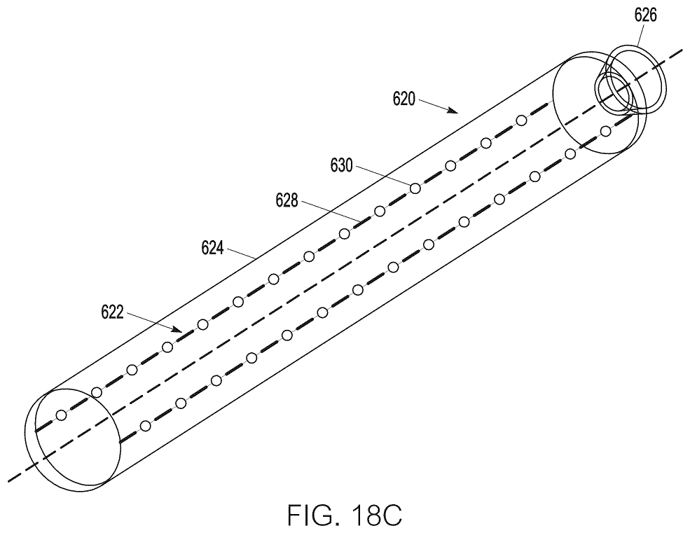

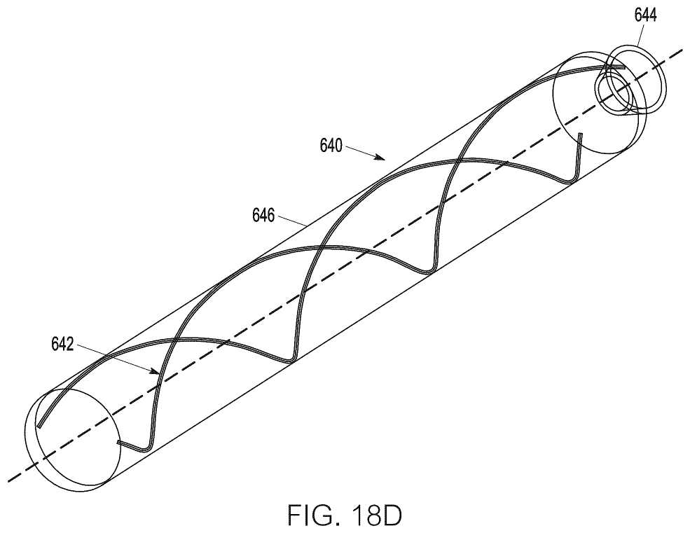

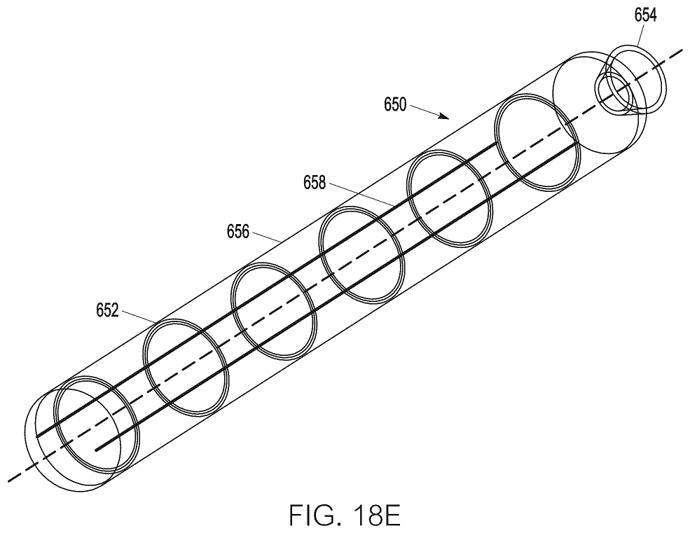

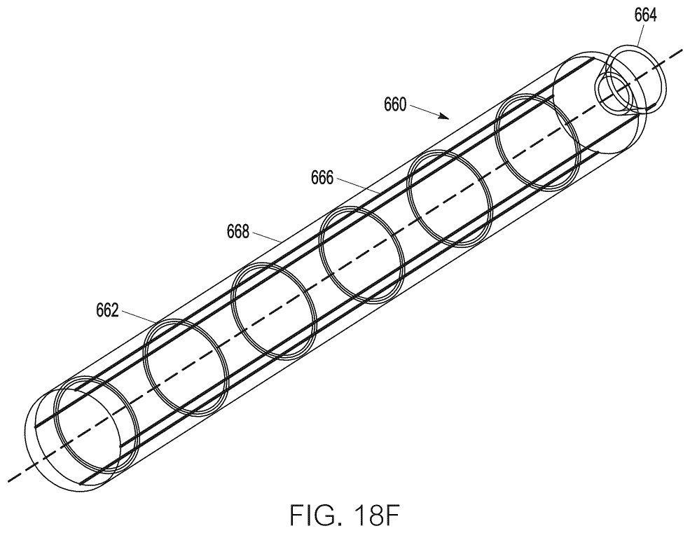

To effectively disable the rocket motor, the energetic material and the outward and inward facing ECAs should extend along the long axis of the rocket motor from the bulkhead to the aft end of the rocket motor. There are many possible configurations for the axial structure of the ECAs, a few of which are illustrated in FIGS. 18A-18F. The particular configuration will depend on the design of the rocket motor and the solid propellent. For simplicity of illustration, each axial structure is assumed to include an integrated ECA.

Referring now to FIG. 18A, a rocket motor 600 includes a plurality of N=4 linear ECAs 602 formed in an energetic material between the casing 604 and the solid propellent (not shown) that extend along a long axis 606 of the rocket motor 600. Each ECA 602 is a single continuous uniform linear structure e.g., a LSC, Chevron or hemispheric charge that extends along the long axis. The ECAs 602 may be evenly spaced at 360/N degree intervals radially about the axis.

Referring now to FIG. 18B, a rocket motor 610 includes a plurality of N=4 segmented linear ECAs 612 formed in an energetic material between the casing 614 and the solid propellent (not shown) that extend along a long axis 616 of the rocket motor 610. Each segmented linear ECA 612 includes a plurality of ECAs 618 separated by energetic material or det cord 620. The energetic material or det cord 620 allows the shock and detonation to travel along the axis and transfer the shockwave between ECA segments 618. The ECAs 612 may be evenly spaced at 360/N degree intervals radially about the axis.

Referring now to FIG. 18C, a rocket motor 620 includes a plurality of N=2 mixed linear ECAs 622 formed in an energetic material between the casing 624 and the solid propellent (not shown) that extend along a long axis 626 of the rocket motor 620. Each mixed linear ECA 622 includes a plurality of ECAs 628 of a first type such as LSC separated by a plurality of ECAs 630 of a second type such as a spheric charge or explosive. The ECAs 622 may be evenly spaced at 360/N degree intervals radially about the axis.

Referring now to FIG. 18D, a rocket motor 640 includes a plurality of N=2 ECA structures 642 that are wrapped in a spiral structure around and along a long axis 644 of rocket motor 640. The ECA structure 642 are formed in an energetic material between a casing 646 and the solid propellent (not shown). Each ECA structure may be a single continuous uniform structure, a segmented structure or a mixed structure as previously illustrated.

Referring now to FIG. 18E, a rocket motor 650 includes a plurality of N=6 radial (ring-shaped) ECAs 652 spaced apart along a long axis 654 of rocket motor 650. Each ECA 652 is formed in an energetic material between a casing 656 and the solid propellent (not shown). Each ECA structure may be a single continuous uniform structure, a segmented structure or a mixed structure as previously illustrated. The radial ECAs 652 are connected by energetic material or det cord 658 to allow the shock and detonation to travel along the axis and transfer the shockwave between ECAs 652. Each radial ECA structure may be a single continuous uniform structure, a segmented structure or a mixed structure as previously illustrated.

Referring now to FIG. 18F, a rocket motor 660 includes a plurality of N=6 radial (ring-shaped) ECAs 662 spaced apart along a long axis 664 of rocket motor 660 and a plurality of M=4 linear ECAs 666 spaced around the axis 664. Each ECA is formed in an energetic material between a casing 668 and the solid propellent (not shown). Each ECA structure may be a single continuous uniform structure, a segmented structure or a mixed structure as previously illustrated. The radial ECAs 662 may be detonated by the detonation of linear ECAs 666. Alternately, the radial ECAs 662 may be connected by energetic material or det cord.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

What is claimed is:

1. A rocket motor comprising:
a casing having a long axis;
a solid propellent;
an energetic material between the solid propellent and the casing; and
an initiator that is operatively coupled to the energetic material to detonate the energetic material;
wherein the energetic material is configured to burn along with the solid propellent to produce thrust in the rocket motor;
wherein a first portion of the energetic material is configured to be capable upon detonation to rupture the casing;
wherein a second portion of the energetic material is configured to be capable upon detonation to break up the solid propellent to terminate thrust.

2. The rocket motor of claim 1, wherein the solid propellent is a Highly Loaded Grain (HLG).

3. The rocket motor of claim 1, wherein the initiator is configured to trigger detonation of the energetic material upon occurrence of one or more circumstances selected from a temperature-related circumstance, a flight-related circumstance and a circumstance of active triggering by a remote operator.

4. The rocket motor of claim 1,
wherein the first portion of the energetic material is part of at least one first embedded charge assembly (ECA) oriented along the long axis and facing outward toward the casing, said at least one first ECA capable upon detonation of the first portion of the energetic material to rupture the casing and expose the solid propellent; and
wherein the second portion of the energetic material is part of at least one second ECA oriented along the long axis and facing inward toward the solid propellent, said second ECA capable upon detonation of the second portion of the energetic material to break up the solid propellent into multiple pieces to terminate thrust.

5. The rocket motor of claim 4, wherein the first and second ECAs are integrated wherein the first portion of energetic material and the second portion of energetic material are a common portion of energetic material.

6. The rocket motor of claim 4, wherein at least one second ECA includes a charge liner configured to distribute sufficient energy in the form of one or more pressure waves to break up the solid propellent.

7. The rocket motor of claim 6, wherein the charge liner is formed of a metal, plastic, ceramic or foam that burns or is reduced to a sufficiently small size to ensure gas venting through a rocket motor nozzle.

8. The rocket motor of claim 4, further comprising an insulative material around each of the at least one second ECAs.

9. The rocket motor of claim 4, wherein the at least one first ECA includes a linear shaped charge (LSC).

10. The rocket motor of claim 9, wherein the at least one first ECA includes a LSC wherein the LSC includes a wedge-shaped charge liner on a surface of the second portion of second portion of energetic material that opens towards the solid propellent.

11. The rocket motor of claim 9, wherein the at least one second ECA includes a Chevron, wherein the Chevron includes an inverted wedge-shaped liner on a surface of the second portion of energetic material that opens away from the solid propellent.

12. The rocket motor of claim 9, wherein the at least one second ECA includes a spheric, wherein the spheric includes a hemispheric, sectioned hemispheric or spherical shaped charge liner on a surface of the second portion of energetic material.

13. The rocket motor of claim 9, wherein the at least one second ECA includes an explosive embedded in the second portion of energetic material.

14. The rocket motor of claim 4, where each of the at least one second ECAs includes a single continuous uniform linear structure that extends along the long axis.

15. The rocket motor of claim 4, wherein each of the at least one second ECAs is a linear structure that includes a mixture of different types of ECAs selected from a LSC, a Chevron, a spheric and an explosive that extend along the axis.

16. The rocket motor of claim 4, wherein a plurality of N second ECAs are formed as linear structures spaced radially around the long axis.

17. The rocket motor of claim 4, wherein a plurality of N second ECAs are formed as radial structures spaced along the long axis.

18. The rocket motor of claim 4, wherein the at least one second ECA is wrapped in spiral structure around the long axis.

19. A rocket motor comprising:
a casing having a long axis; and
a Highly Loaded Grain (HLG) solid propellent;
an energetic material between the solid propellent and the casing; and
an initiator that is operatively coupled to the energetic material to detonate the energetic material;
wherein the energetic material is configured to burn along with the solid propellent to produce thrust in the rocket motor;
wherein a first portion of the energetic material is part of at least one first embedded charge assembly (ECA) oriented along the long axis and facing outward toward the casing, said at least one first ECA capable upon detonation of the first portion of the energetic material to rupture the casing and expose the solid propellent; and
wherein a second portion of the energetic material is part of at least one second ECA oriented along the longitudinal axis and facing inward toward the solid propellent, said second ECA capable upon detonation of the second portion of the energetic material to break up the solid propellent into multiple pieces to terminate thrust without detonating the solid propellent.

20. A rocket motor comprising:
a casing;
a solid propellent;
an energetic material; and
an initiator that is operatively coupled to the energetic material to detonate the energetic material;
wherein the energetic material is configured to burn along with the solid propellent to produce thrust in the rocket motor;
wherein the energetic material is configured to be capable upon detonation to rupture the casing or to break up the solid propellent into pieces.
